(19) United States
(12) Patent Application Publication
(10) Pub. No.: US 2015/0092511 A1
(43) Pub. Date: Apr. 2, 2015

(54) SHEAR-THINNING OF SLURRIES

(71) Applicant: DELKOR TECHNIK B.V., Amsterdam (NL)

(72) Inventors: Mark David Taylor, Sydney (AU); David Neil Minson, Vancouver (CA); Marcelo Navarro, Santiago (CL)

(21) Appl. No.: 14/385,313

(22) PCT Filed: Mar. 19, 2013
(86) PCT No.: PCT/IB2013/052162

§ 371 Date: Sep. 15, 2014

(30) Foreign Application Priority Data
Mar. 19, 2012 (ZA) 2012/02028

(51) Int. Cl. B01D 21/24; B01F 7/00; C02F 11/00; B01F 5/10

(52) U.S. Cl. CPC B01D 21/2488; B01F 5/10; B01F 7/00; C02F 11/00; B01F 2215/0052
USPC 366/136

(57) ABSTRACT

A method of shear-thinning a slurry includes transferring slurry to be shear-thinned from a primary vessel or reservoir to a secondary vessel or reservoir, withdrawing at least a portion of the slurry in the secondary vessel or reservoir by means of a pump or motive device as a shear device thereby shear-thinning the withdrawn slurry, and returning or recycling at least a portion of the shear-thinned slurry back to the secondary vessel or reservoir. The slurry is withdrawn through an outlet from the secondary vessel or reservoir and is returned to the secondary vessel or reservoir through an inlet into the secondary vessel or reservoir with the inlet being spaced from the outlet. The returned shear-thinned slurry has a reduced yield stress compared to slurry in the primary vessel or reservoir and the returned shear-thinned slurry is allowed to mix in the secondary vessel or reservoir with slurry transferred from the primary vessel or reservoir thereby to lower the overall yield stress of slurry in the secondary vessel or reservoir. Some of the slurry in the secondary vessel or reservoir with the lower overall yield stress is transferred away.

### FIELD OF INVENTION

This invention relates to shear-thinning of slurries. In particular, the invention relates to a method of shear-thinning a slurry and to shear-thinning apparatus.

### BACKGROUND OF INVENTION

Devices such as hydrocyclones or gravity settlers are sometimes referred to as thickeners owing to the fact that they are typically used in industry to produce a thickened slurry, having a high solids content, from a diluted slurry having high a water content. Such thickeners are used in various applications. A particular though not exclusive application is to dispose of residual particulate material known as tailings, which is produced as a waste product in mining operations, in an environmentally friendly manner to an emplacement, e.g. a tailings dam. Through the use of a hydrocyclone, for example, diluted tailings may be separated into an underflow portion having a higher solids content and an overflow portion having a higher water content.

Irrespective of the process used to produce a thickened slurry, one very often has the situation of a thickened slurry being produced and contained in a vessel or apparatus of some description, with a requirement for the thickened slurry to be transported or transferred by means of one or more pumps, to a location remote from said vessel or apparatus.

If the solids content, and hence the viscosity, of a slurry becomes too high it may become difficult to handle or transport the slurry by means of a pump. Instead of continuously flowing through transportation equipment such as a feed or suction pipe of a pump, the slurry flow may become restricted to the point of forming a blockage. For some slurries, it may thus be necessary to lower the viscosity of the slurry in order to improve the flow characteristics of the slurry and hence to facilitate or improve handling thereof, and in particular to allow pumping thereof. One way of doing so is known as shear thinning. Shear thinning can be applied to slurries showing shear-thinning visco-plastic rheological properties (i.e. to non-Newtonian fluids) and has the advantage that the slurry is not diluted by adding a carrier medium, e.g. water, in order to thin the slurry. This is important, as it is generally from an economical point of view advantageous to handle or transport a slurry with the highest practical solids concentration, with the lowest possible viscosity.

### SUMMARY OF INVENTION

According to one aspect of the invention, there is provided a method of shear-thinning a slurry, the method including

transferring slurry to be shear-thinned from a primary vessel or reservoir to a secondary vessel or reservoir;

withdrawing at least a portion of the slurry in the secondary vessel or reservoir by means of a pump or motive device acting as a shear device thereby shear-thinning the withdrawn slurry in the pump;

returning or recycling at least a portion of said shear-thinned slurry back to the secondary vessel or reservoir, the slurry to be shear-thinned being withdrawn through an outlet from the secondary vessel or reservoir and the shear-thinned slurry being returned to the secondary vessel or reservoir through an inlet into the secondary vessel or reservoir, the inlet being spaced from the outlet and the returned shear-thinned slurry thus having a reduced yield stress compared to slurry in the primary vessel or reservoir;

allowing the returned shear-thinned slurry to mix in the secondary vessel or reservoir with slurry transferred from the primary vessel or reservoir thereby to lower the overall yield stress of slurry in the secondary vessel or reservoir; and

transferring away from the secondary vessel or reservoir some of said slurry in the secondary vessel or reservoir with the lower overall yield stress.

Said some of said slurry in the secondary vessel or reservoir with the lower overall yield stress may be transferred away from the secondary vessel or reservoir continuously or intermittently, whilst said at least a portion of said shear-thinned slurry is of course recycled continuously back to the secondary vessel or reservoir. Slurry to be shear-thinned may thus also be transferred continuously or intermittently from the primary vessel or reservoir to the secondary vessel or reservoir. In a preferred embodiment of the method of the invention, the method however provides a continuous process of shear thinning, with slurry to be shear-thinned being transferred continuously from the primary vessel or reservoir to the secondary vessel or reservoir and with said some of said slurry in the secondary vessel or reservoir with the lower overall yield stress being transferred away from the secondary vessel or reservoir continuously.

The pump or motive device may be a high shear pump or high shear motive device. For ease of reference, the term “pump” is used hereinafter, but it is to be understood that the term pump is intended to include any motive device capable of acting as a shear device.

The slurry to be shear-thinned may be transferred under gravity from the primary vessel or reservoir to the secondary vessel or reservoir. Instead, or in addition, the slurry to be shear-thinned may be transferred under pressure from the primary vessel or reservoir to the secondary vessel or reservoir.

The ratio of the mass flow rate of slurry to be shear-thinned being transferred from the primary vessel or reservoir to the secondary vessel or reservoir, to the shear-thinned slurry being recycled by means of said pump, may be at least about 1:0.25, preferably at least about 1:1 or about 1:2, e.g. between about 1:1 and about 1:5. Typically, the ratio of the mass flow rate of slurry to be shear-thinned being transferred from the primary vessel or reservoir to the secondary vessel or reservoir, to the shear-thinned slurry being recycled by means of said pump, is not higher than about 1:5 in order to contain capital and operating costs associated with the pumping around of the slurry to be shear-thinned.

The slurry to be shear-thinned may have a yield stress of more than about 20 Pa. The yield stress may even be higher, e.g. higher than about 100 Pa or higher than about 200 Pa or higher than about 225 Pa or higher than about 250 Pa, e.g. between about 250 Pa and about 350 Pa.

The returned shear-thinned slurry will naturally have a lower yield strength than the slurry to be shear-thinned. For example, if the slurry to be shear-thinned has a yield stress of 200 Pa then the returned shear-thinned slurry will have a yield strength of less than 200 Pa. Depending on the initial yield strength of the slurry to be shear-thinned, the returned shear-thinned slurry may have a yield strength as low as 10 Pa.

The method may include agitating the slurry in the secondary vessel or reservoir, e.g. using a mechanical agitator. As will be appreciated, this agitation action will lead to shear thinning in addition to the shear thinning achieved by the pump as a shear device.

The inlet into the secondary vessel or reservoir may be a tangential inlet. In other words, returning or recycling at least a portion of said shear-thinned slurry back to the secondary vessel or reservoir through said inlet may include discharging said shear-thinned slurry in tangential fashion into an interior of the secondary vessel or reservoir.

The volume of the secondary vessel or reservoir may be sufficient to provide a residence time for slurry to be shear-thinned of between about 5 seconds and about 300 seconds. In other words, the method may include ensuring that slurry to be shear-thinned has a nominal residence time of between about 5 seconds and about 300 seconds in the secondary vessel or reservoir, in particular when the method of the invention is employed as a continuous method or process.

According to another aspect of the invention, there is provided a shear-thinning apparatus or facility for lowering the yield stress of a slurry, the apparatus or facility including

a primary vessel or reservoir for holding a slurry to be shear thinned;

a secondary vessel or reservoir in flow communication with the primary vessel or reservoir, the secondary vessel or reservoir having an outlet; and

at least one pump or motive device to act as a shear device in flow communication with said outlet to receive slurry from the secondary vessel or reservoir and also in flow communication with an inlet discharging into the secondary vessel or reservoir to return shear-thinned slurry to the secondary vessel or reservoir; and

transfer means in flow communication with the secondary vessel or reservoir to transfer shear-thinned slurry away from the secondary vessel or reservoir.

The primary vessel or reservoir may be arranged relative to the secondary vessel or reservoir to allow slurry to be shear thinned to be transferred under gravity from the primary vessel or reservoir to the secondary vessel or reservoir. Instead, or in addition, the slurry to be shear-thinned may be transferred under pressure from the primary vessel or reservoir to the secondary vessel or reservoir. The shear-thinning apparatus or facility may thus include pressure means to transfer slurry to be shear-thinned under pressure from the primary vessel or reservoir to the secondary vessel or reservoir.

The secondary vessel or reservoir may be in flow communication with the primary vessel or reservoir by means of a transfer pipe or conduit. Similarly, the pump may be in flow communication with the outlet of the secondary vessel or reservoir by means of a suction pipe or a conduit or a pump suction. The cross-sectional area of the transfer pipe or conduit may be at least about 25% of the cross-sectional area of the suction pipe or conduit or pump suction. Preferably, the cross-sectional area of the transfer pipe or conduit is at least about 50% of the cross-sectional area of the suction pipe or conduit or pump suction, more preferably at least about equal the cross-sectional area of the suction pipe or conduit or pump suction, e.g. between about two and about three times the cross-sectional area of the suction pipe or conduit or pump suction.

Preferably, the inlet discharging into the secondary vessel or reservoir is at a higher elevation than the outlet in flow communication with the pump. In at least one embodiment of the invention, this arrangement is however reversed, with the inlet discharging into the secondary vessel or reservoir being at a lower elevation than the outlet in flow communication with the pump.

The pump may be a centrifugal pump.

Typically, said flow communication between the pump and the inlet discharging into the secondary vessel or reservoir is established by a return conduit or pipe extending between the pump and said inlet discharging into the secondary vessel or reservoir. The inlet discharging into the secondary vessel or reservoir may thus be an outlet of said return conduit or pipe between the pump and the secondary vessel or reservoir. The return conduit or pipe may be circular cylindrical.

The inlet discharging into the secondary vessel or reservoir and the outlet in flow communication with the pump may be spaced a distance at least about equal to the outside diameter of the return conduit or pipe. In some embodiments of the invention, the inlet discharging into the secondary vessel or reservoir and the outlet in flow communication with the pump are spaced a distance equal to at least about twice the outside diameter of the return conduit or pipe.

The transfer pipe or conduit may have an outlet into the secondary vessel or reservoir, i.e. in a wall of the secondary vessel or reservoir. This outlet may be coaxial with and diametrically or diagonally opposed to the outlet in flow communication with the pump, or it may be angularly displaced relative to said outlet in flow communication with the pump. The outlet of the transfer pipe or conduit and the outlet in flow communication with the pump may be positioned toward a bottom of the secondary vessel or reservoir. Instead, the outlet of the transfer pipe or conduit may be elevated above the outlet in flow communication with the pump.

The cross-sectional area of the outlet of the transfer pipe or conduit may be at least about 25% the cross-sectional area of the outlet in flow communication with the pump. Preferably, the cross-sectional area of the outlet of the transfer pipe or conduit is at least about 50%, more preferably at least about equal to, the cross-sectional area of the outlet in flow communication with the pump.

These cross-sectional areas are taken where the outlets open out into the secondary vessel or reservoir.

It is to be appreciated that the inlet discharging into the secondary vessel or reservoir does not necessarily have to pass through a wall of the secondary vessel or reservoir. For example, the inlet discharging into the secondary vessel or reservoir may be said outlet from said return conduit or pipe which is arranged to discharge into the secondary vessel or reservoir without passing through a wall of the secondary vessel or reservoir. Similarly, in principle, the outlet of the transfer pipe or conduit does not necessarily have to pass through a wall of the secondary vessel or reservoir. In most embodiments of the invention however, the inlet discharging into the secondary vessel or reservoir and the outlet of the transfer pipe or conduit will pass through a wall of the secondary vessel or reservoir, which is then typically a pressure vessel.

The transfer means in flow communication with the secondary vessel or reservoir may include a conduit branching off from the return conduit, between the pump and the inlet discharging into the secondary vessel or reservoir. Preferably, however, the transfer means in flow communication with the secondary vessel or reservoir includes a transfer outlet from the secondary vessel or reservoir.

The apparatus may include a transfer pump in flow communication with the transfer outlet. The transfer pump may be configured to operate independently from the pump acting as a shear device.

The transfer outlet may be separate from the outlet in flow communication with the pump. The transfer outlet may be positioned toward the bottom of the secondary vessel or reservoir. The transfer outlet may be coaxial with and diametrically or diagonally opposed to the outlet in flow communication with the pump, or the transfer outlet may be in the same vertical plane as the outlet in flow communication with the pump. In other words, the transfer outlet and the outlet in flow communication with the pump may be in diametrically or diagonally opposed positions on the secondary vessel or reservoir.

The apparatus may include an agitator arranged in use to agitate slurry in the secondary vessel or reservoir. As will be appreciated, this agitation action will in use lead to shear thinning in addition to the shear thinning achieved by the pump as a high shear device.

As will be appreciated, the secondary vessel or reservoir will have a volume determined at least partially by the volumetric flow of slurry to be shear-thinned from the primary vessel or reservoir. Preferably, the volume of the secondary vessel or reservoir is sufficient to provide a residence time for slurry to be shear-thinned of between about 5 seconds and about 300 seconds.

The inlet discharging into the secondary vessel or reservoir may be arranged to discharge shear-thinned slurry tangentially against an interior surface of the secondary vessel or reservoir.

The primary vessel or reservoir may form part of a thickener or settler, in particular part of a gravity thickener or settler.

The invention thus extends to a thickener or settler which includes

a primary vessel or reservoir to separate a solids-containing liquid into a thickened underflow and a clarified overflow;

a secondary vessel or reservoir in flow communication with the primary vessel or reservoir, the secondary vessel or reservoir having an outlet; and

at least one pump or motive device to act as a shear device in flow communication with said outlet to receive slurry from the secondary vessel or reservoir and also in flow communication with an inlet discharging into the secondary vessel or reservoir to return shear-thinned slurry to the secondary vessel or reservoir; and transfer means in flow communication with the secondary vessel or reservoir to

transfer shear-thinned slurry away from the secondary vessel or reservoir.

### BRIEF DESCRIPTION OF DRAWINGS

The invention will now be further described, with reference to the Example and to the accompanying exemplifying drawings in which

FIG. 1 illustrates a three-dimensional view of one embodiment of a shear thinning apparatus in accordance with the invention;

FIG. 2 illustrates a side view of another embodiment of a shear-thinning apparatus in accordance with the invention; and

FIG. 3 shows a plan view of the apparatus of FIG. 2

### DETAILED DESCRIPTION OF ONE EMBODIMENT

Referring to the drawing, reference numeral 10 refers generally to a shear thinning apparatus for lowering the viscosity or yield stress of a high solids content slurry in accordance with the method of the invention. The apparatus 10 includes a high efficiency gravity settler 12, only a lower portion of which is shown, with the lower portion defining a primary vessel 14. A transfer pipe 16 establishes flow communication between the primary vessel 14 and a secondary circular cylindrical vessel 18. The secondary vessel 18 is a closed pressure vessel, and has a flanged, cylindrical inlet 15 which protrudes outwardly from a bottom of the secondary vessel 18 and a flanged, cylindrical withdrawal or transfer outlet 20 which is positioned marginally below the inlet 15, at a right angle thereto. The cross-sectional area of the inlet 15 is greater than the cross-sectional area of the transfer outlet 20. The inlet 15 defines in fact an outlet for the transfer pipe 16.

Another outlet, hereinafter referred to as the circulation outlet 22 is provided diametrically or diagonally opposite the inlet 15 such that the circulation outlet 22 is aligned and coaxial with the inlet 15.

The apparatus 10 includes a shear thinning device in the form of an in-line centrifugal fluid pump 24. The pump 24 is powered by an electrical motor 26 which is drivingly connected to the pump 24 by way of a belt and pulley system and a gearbox (not shown explicitly). The electrical motor 26 may be positioned on a stand as shown in the drawing.

A suction pipe 34 is connected to the outlet 22 and to the pump 24 and establishes flow communication between the secondary vessel 18 and the pump 24.

Another inlet 36 is provided tangentially toward a top of the vessel 18. A return pipe 40 establishes flow communication between a discharge of the pump 24 and the inlet 36. An in-line manually operated valve 38 is provided adjacent to the inlet 36.

The secondary vessel 18, being a pressure vessel, has a closed top as shown in the drawing. In principle however, the secondary vessel 18 may be open-topped, with the pipe 40 crossing over a rim of such an open-topped vessel and the inlet 36 merely discharging into the secondary vessel without passing through a wall of the secondary vessel. It is however expected that in most applications the secondary vessel 18 will be a pressure vessel.

The inlet 15 (i.e. the outlet of the transfer pipe 16) is therefore in flow communication with the transfer outlet 20 and the circulation outlet 22. When the valve 38 is open, the circulation outlet 22 is in flow communication with the inlet 36 via the pump 24 thus forming a pump around loop for the secondary vessel 18.

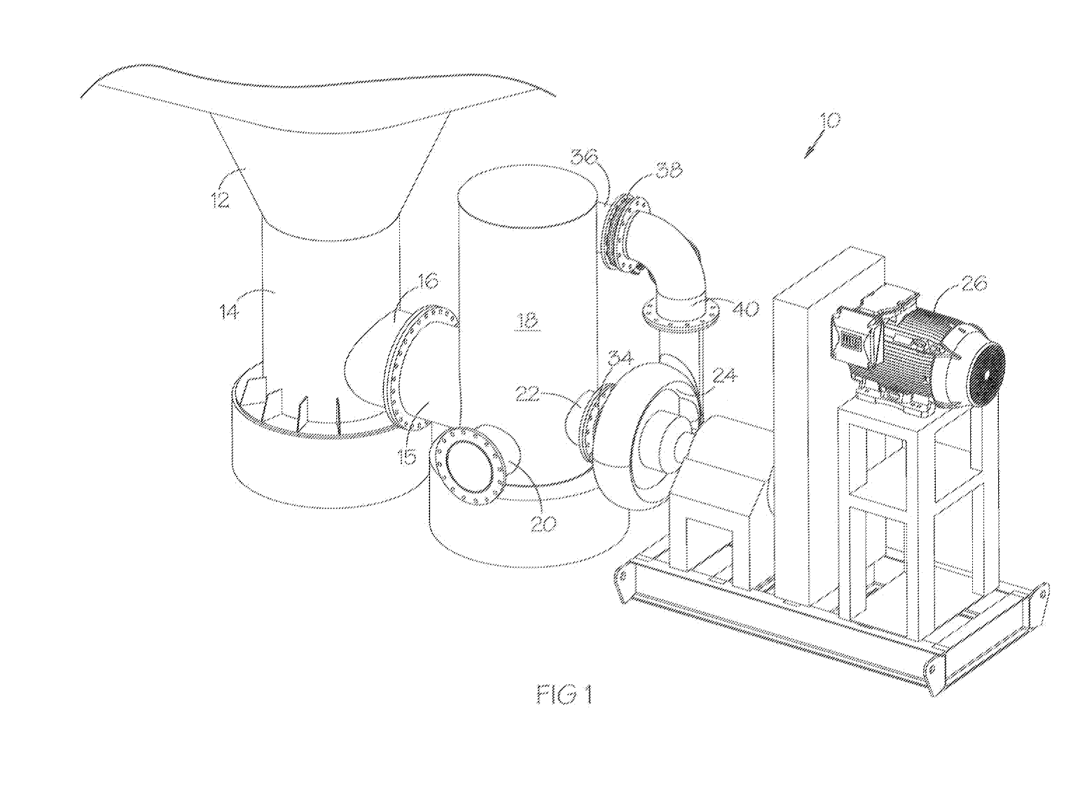

The cross-sectional area of the transfer pipe 16 should be at least 25% that of the suction pipe 34. In the embodiment shown in FIG. 1, the cross-sectional area of the transfer pipe 16 is larger than that of the suction pipe 34.

It is to be understood that a high solids content slurry often needs to be transported or transferred from equipment in which the slurry is formed or held, such as the settler 12, to destinations where the slurry may be used, treated or discarded. Many times this is done with difficulty due to the slurry's high, paste-like yield stress which makes it resistant to flow. In order to facilitate the discharge or transportation of such a slurry, it is necessary to reduce its yield stress. This can be done by subjecting the slurry to a mechanical shear device or mechanical fluid pump such as the centrifugal pump 24 which acts as a high shear device thereby to modify the rheological properties of the paste-like slurry by breaking bonds formed between the solids particles in the slurry.

The gravity settler 12 has a frusto-conical upper part 42 which leads into the primary vessel 14 which is circular cylindrical. In use, a slurry is thus thickened in conventional fashion in the gravity settler 12 with a thickened underflow collecting in the primary vessel 14. The operation of gravity settlers and thickeners and the like is well known to those skilled in the art and is not discussed in any further detail.

Under the force of gravity, a high viscosity or high yield stress slurry formed in the primary vessel 14 passes through the pipe 16 to the secondary vessel 18. The relatively large diameter of the transfer pipe 16 facilitates transfer of the slurry.

Part of the slurry in the secondary vessel 18 is withdrawn from the vessel 18 through the circulation outlet 22 by means of the pump 24, which then circulates the slurry back to the secondary vessel 18 through the inlet 36. The rate of circulation of the slurry around the secondary vessel 18 is generally greater than the rate of transfer of slurry from the primary vessel 14 into the secondary vessel 18, although in some embodiments of the invention the circulation rate may be as low as only 25% the rate of transfer of slurry from the primary vessel 14 into the secondary vessel 18.

The pump 24 acts as a high shear device, which has the effect of lowering the apparent viscosity and the yield stress of the slurry being circulated. The slurry with reduced yield stress mixes with high yield stress slurry in the secondary vessel 18 thereby lowering the average yield stress of the slurry inside the secondary vessel 18. The pumping around of the slurry over time reduces the average yield stress of slurry in the secondary vessel 18 so that the average yield stress approaches that of the slurry being circulated, reaching a substantially steady state of operation.

A portion of the mixed slurry in the secondary vessel 18 which now has a sufficiently low yield stress is permanently withdrawn through the transfer outlet 20, e.g. by means of another pump (not shown). For the embodiment shown in FIG. 1, the rate of withdrawal through the transfer outlet 20 is substantially the same as the rate of feeding of slurry through the inlet 15, allowing the apparatus 10 to reach and be operated at a steady state. The withdrawn slurry can be transported to a desired location via suitable piping.

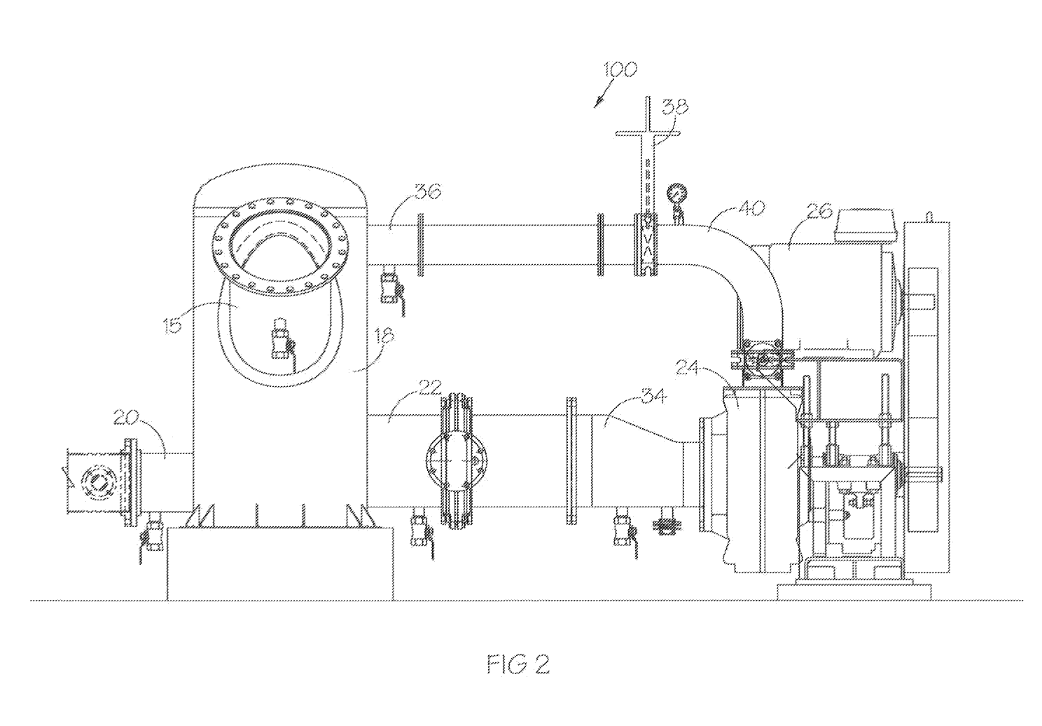

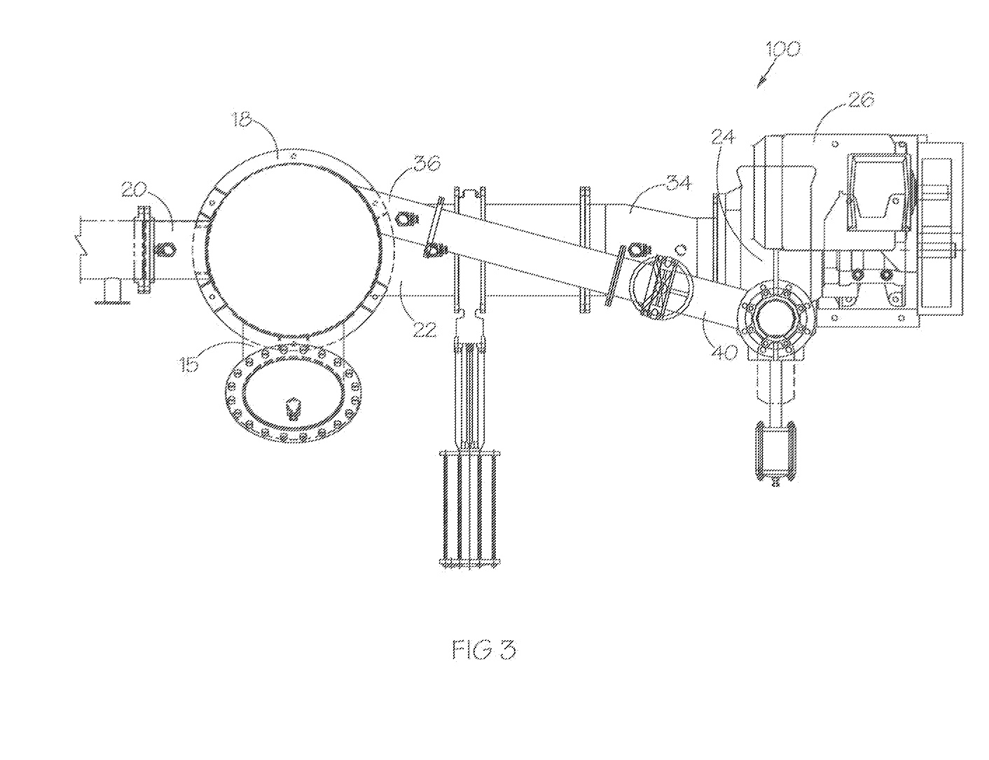

Referring to FIGS. 2 and 3, another embodiment of a shear-thinning apparatus in accordance with the invention is generally indicated by reference numeral 100. The apparatus 100 is similar to the apparatus 10 and unless otherwise indicated, the same reference numerals are used in FIGS. 2 and 3 to indicate features that are the same as or similar to features indicated by those reference numerals in FIG. 1.

In FIGS. 2 and 3, the gravity settler 12 and the transfer pipe 16 are not indicated. The inlet 15 is however upwardly slanted to receive slurry from above under gravity from the gravity settler. The inlet 15 is also not coaxial with the outlet 22, and is elevated above the outlet 22. The tangential inlet 36 and the inlet 15 are arranged to ensure that slurry discharged from the inlet 36 swirls around the secondary vessel 18 and impacts or entrains slurry received through the inlet 15.

### EXAMPLE

The following example illustrates the advantages of implementing the apparatus 10 as described above. A thickener with a high side wall (>4 m) and a steep floor slope (>20 degrees) treating a copper tailings slurry produced a thickened underflow slurry having a density of 68% (w/w) at an outlet or underflow nozzle of the thickener. When measured with a rheological device, the slurry at the outlet exhibited a yield stress of 245 Pa. When the thickener was modified to resemble the apparatus 10, i.e. when the secondary vessel 18 was attached to the outlet or underflow nozzle of the thickener by means of the pipe 16, the slurry was circulated and recirculated by the pump 24 via the pump around loop as described above. The slurry was recirculated at a high mass flow rate when compared with the mass flow rate of slurry from the thickener outlet into the secondary vessel 18. The yield stress of the mixed slurry formed in the secondary vessel 18 was measured after about two minutes using the same rheological device and found to be 115 Pa.

It is clear that the use of the method of the invention produced a significant reduction in the yield stress of the slurry which means that the slurry is more easily transportable.

The Inventors believe that the apparatus 10, 100 and the method of the invention, as illustrated, provide a cost effective solution to the difficulties experienced in the handling and transportation of high solids content slurries. Existing thickening devices or slurry storage devices can easily be retrofitted with additional components such as the secondary vessel 18 and the pump 24 to form a shear-thinning apparatus 10,100 in accordance with the invention which employs the method of the invention. As slurry is circulated around the secondary vessel 18 and not around the primary vessel 14, there is no risk that the recirculated slurry could have any negative effect on flow patterns in or around the primary vessel 14, or on the operation of the primary vessel 14 or a device of which the primary vessel 14 forms part. With the apparatus and method of the invention, as illustrated, there is thus no need to use a thickener also as a shear thinning or stress reduction device. When a thickener is also used as a shear thinning or stress reduction device, the stress reduction volume is not external to the thickener and is difficult to control, whereas the use of the secondary vessel allows better control of the shear thinning process. Advantageously, the secondary vessel has the potential to allow shear thinning or stress reduction both by means of recirculation using a pump and also by means of an agitator. Furthermore, as the secondary vessel 18 can (in many instances) be connected to an existing underflow outlet of a thickener or settler or similar apparatus, it may not be necessary to cut and/or weld the existing apparatus.

1. A method of shear-thinning a slurry, the method including
transferring slurry to be shear-thinned from a primary vessel or reservoir to a secondary vessel or reservoir;
withdrawing at least a portion of the slurry in the secondary vessel or reservoir by means of a pump or motive device acting as a shear device thereby shear-thinning the withdrawn slurry in the pump or motive device;
returning or recycling at least a portion of said shear-thinned slurry back to the secondary vessel or reservoir, the slurry to be shear-thinned being withdrawn through an outlet from the secondary vessel or reservoir and the shear-thinned slurry being returned to the secondary vessel or reservoir by discharging said shear-thinned slurry in tangential fashion into an interior of the secondary vessel or reservoir through an inlet into the secondary vessel or reservoir, the inlet being spaced from the outlet and the returned shear-thinned slurry thus having a reduced yield stress compared to slurry in the primary vessel or reservoir;
allowing the returned shear-thinned slurry to mix in the secondary vessel or reservoir with slurry transferred from the primary vessel or reservoir thereby to lower the overall yield stress of slurry in the secondary vessel or reservoir; and
transferring away from the secondary vessel or reservoir some of said slurry in the secondary vessel or reservoir with the lower overall yield stress.

2. The method as claimed in claim 1, in which the slurry to be shear-thinned is transferred under gravity or under pressure from the primary vessel or reservoir to the secondary vessel or reservoir.

3. The method as claimed in claim 1 in which the ratio of the mass flow rate of slurry to be shear-thinned being transferred from the primary vessel or reservoir to the secondary vessel or reservoir, to the shear-thinned slurry being recycled by means of said pump or motive device, is at least 1:0.25.

4. The method as claimed in claim 3, in which the ratio of the mass flow rate of slurry to be shear-thinned being transferred from the primary vessel or reservoir to the secondary vessel or reservoir, to the shear-thinned slurry being recycled by means of said pump or motive device, is at least 1:1.

5. (canceled)

6. The method as claimed in claim 1 which includes agitating the slurry in the secondary vessel or reservoir.

7. The method as claimed in claim 1 in which the volume of the secondary vessel or reservoir is sufficient to provide a residence time for slurry to be shear-thinned of between 5 seconds and 300 seconds.

8. A shear-thinning apparatus or facility for lowering the yield stress of a slurry, the apparatus or facility including
a primary vessel or reservoir for holding a slurry to be shear thinned;
a secondary vessel or reservoir in flow communication with the primary vessel or reservoir, the secondary vessel or reservoir having an outlet; and
at least one pump or motive device to act as a shear device in flow communication with said outlet to receive slurry from the secondary vessel or reservoir and also in flow communication with an inlet discharging into the secondary vessel or reservoir to return shear-thinned slurry to the secondary vessel or reservoir, the inlet discharging into the secondary vessel or reservoir being arranged to discharge shear-thinned slurry tangentially against an interior surface of the secondary vessel or reservoir; and
transfer means in flow communication with the secondary vessel or reservoir to transfer shear-thinned slurry away from the secondary vessel or reservoir.

9. The apparatus or facility as claimed in claim 8, in which the primary vessel or reservoir is arranged relative to the secondary vessel or reservoir to allow slurry to be shear thinned to be transferred under gravity from the primary vessel or reservoir to the secondary vessel or reservoir, or which includes pressure means to transfer slurry to be shear-thinned under pressure from the primary vessel or reservoir to the secondary vessel or reservoir.

10. The apparatus or facility as claimed in claim 8 in which the secondary vessel or reservoir is in flow communication with the primary vessel or reservoir by means of a transfer pipe or conduit and in which the pump or motive device is in flow communication with the outlet of the secondary vessel or reservoir by means of a suction pipe or a conduit, the cross-sectional area of the transfer pipe or conduit being at least 25% of the cross-sectional area of the suction pipe or conduit.

11. The apparatus or facility as claimed in claim 9, in which the cross-sectional area of the transfer pipe or conduit is at least equal to the cross-sectional area of the suction pipe or conduit.

12. (canceled)

13. The apparatus or facility as claimed in claim 8 in which the secondary vessel or reservoir has a volume sufficient to provide a residence time for slurry to be shear-thinned of between 5 seconds and 300 seconds.

14. The apparatus or facility as claimed in claim 8 which includes an agitator arranged in use to agitate slurry in the secondary vessel or reservoir.

15. The apparatus or facility as claimed in claim 8 in which the primary vessel or reservoir forms part of a gravity thickener or settler.

16. The method as claimed in claim 2 in which the ratio of the mass flow rate of slurry to be shear-thinned being transferred from the primary vessel or reservoir to the secondary vessel or reservoir, to the shear-thinned slurry being recycled by means of said pump or motive device, is at least 1:0.25.

17. The method as claimed in claim 16 in which the ratio of the mass flow rate of slurry to be shear-thinned being transferred from the primary vessel or reservoir to the secondary vessel or reservoir, to the shear-thinned slurry being recycled by means of said pump or motive device, is at least 1:1.

18. The method as claimed in claim 2 which includes agitating the slurry in the secondary vessel or reservoir.

19. The method as claimed in claim 3 which includes agitating the slurry in the secondary vessel or reservoir.

20. The method as claimed in claim 4 which includes agitating the slurry in the secondary vessel or reservoir.

21. The apparatus or facility as claimed in claim 9 in which the secondary vessel or reservoir is in flow communication with the primary vessel or reservoir by means of a transfer pipe or conduit and in which the pump or motive device is in flow communication with the outlet of the secondary vessel or reservoir by means of a suction pipe or a conduit, the cross-sectional area of the transfer pipe or conduit being at least 25% of the cross-sectional area of the suction pipe or conduit.

22. The apparatus or facility as claimed in claim 9 in which the secondary vessel or reservoir has a volume sufficient to provide a residence time for slurry to be shear-thinned of between 5 seconds and 300 seconds.
